(19) United States
(12) Patent Application Publication
(10) Pub. No.: US 2014/0298894 A1
(43) Pub. Date: Oct. 9, 2014

(54) LINE PRESSURE TESTING TECHNIQUE

(71) Applicant: SCHLUMBERGER TECHNOLOGY CORPORATION, Sugar Land, TX (US)

(72) Inventors: Michael James Alff, Houston, TX (US); Melissa Odom, Lockport, LA (US); Lee Jackson, Aberdeen (GB)

(73) Assignee: Schlumberger Technology Corporation, Sugar Land, TX (US)

(21) Appl. No.: 13/859,357

(22) Filed: Apr. 9, 2013

(51) Int. Cl. G01M 3/28

(52) U.S. Cl. CPC G01M 3/2838
USPC 73/46

(57) ABSTRACT

A system and technique for pressure testing a line portion, connection, or other linking piece of unknown leak characteristics. The technique includes applying predetermined pressure to the linking piece to be tested as well as to another of known non-leaking characteristics. Thus, a differential of recorded pressures may be monitored over time and against a predetermined known parameter. For example, an acceptance boundary with a set level of confidence may be established against which the differential may be evaluated. The boundary may be developed by prior testing of known non-leaking characteristics.

### BACKGROUND

Exploring, drilling, completing, and operating hydrocarbon and other wells are generally complicated, time consuming, and ultimately very expensive endeavors. Thus, in order to maximize hydrocarbon recovery from underground reservoirs, hydrocarbon wells are becoming of increasingly greater depths and more sophisticated. For example, wells exceeding 25,000 feet in depth which are highly deviated are becoming increasingly common Similarly, in addition to increasing depths, wells and well completion hardware are also becoming of increasing complexity. For example, multi-staged lower, intermediate and upper completion assemblies may be outfitted with a host of different tools and instrumentation over the span of tens of thousands of feet as noted.

Much of the downhole hardware in completions is of a more passive nature such as gravel packing hardware or unintelligent valves and shifting devices actuated by follow-on interventional actuation. However, many tools are equipped with power and/or telemetry running to the oilfield surface so as to allow ongoing powering and/or communications without the requirement of intervention. For example, an electric submersible pump, packer gauges, valve acutators and the like may retain a physical line linked up to the surface at all times for sake of monitoring or responding to well conditions on an ongoing or real-time basis.

As a practical matter, the various line link-ups that may be required will often result in a series of splices, terminations and other cable connections, perhaps even within a single cable. This may be preferable to running an excessive number of dedicated cables to separate downhole tools. That is, an operator at surface may have several tools gauges, etc. with cable emerging at either side thereof, for both uphole and downhole connection to additional cable and other tools as needed. Thus, a series of tools for a given completion may be provided with any necessary cabled powering or telemetry needs running to the surface over a single line.

Of course, given the likely pressures of the downhole environment, the splices in the cable may be pressure tested before being deployed into the well. For example, protocol may call for a pressure rating of 20,000 PSI for all downhole cables, connections, cable splices, terminations, etc. that are utilized in a given well. In this manner, assurances may be provided to verify the connection seals and that a pressure induced leak will not result in which well fluids damage the cable, a tool or its functionality. Thus, while the initial or uncut portions of the cable may be delivered to the oilfield appropriately tested and qualified at such a rating, each new splice made at the wellsite may require its own new verification testing.

Pressure testing of a splice is generally achieved by clamping a pressure test adaptor such as a C-ring or other suitable pressure interface about a splice, pressuring up a test line connected to the adaptor and recording pressure fluctuations over time. In the particular example of the C-ring, it may be equipped with a needle-like tubular for penetrating the splice, though in other adaptors other sealable port types may be utilized. For example, a pre-positioned re-sealable port may be incorporated into the splice which is specifically tailored to support such testing and to allow for secured resealing of the splice thereafter.

Recorded test results from the above noted pressure testing may be analyzed. For example, as alluded to above, pressure fluctuations over time may be of interest. More specifically, at least in theory, a leakage in the splice may be detected if a pressure drop in the test line is detected.

Unfortunately, running a pressure test in this manner may require monitoring of pressure in the test line for between about 10 and 30 minutes on each given splice. When also accounting for the hook-up time, operator analysis and de-linking, this may translate into as much as an hour and a half per splice test. Thus, with completions of ever increasing complexity, often having ten or more splices and associated tools, this may result into an additional 10 hours or more worth of required completion setup time at the rig floor. Given that operation time may run up to a million dollars per day, unproductive setup time such as this, where hydrocarbon recovery is delayed, may be of significant consequence.

In addition to inherent delays in pressure testing, issues persist in terms of test reliability. That is, as noted above, in theory, a leakage in the splice may be detected if a pressure drop in the test line is detected. However, pressure fluctuations may be the result of a variety of factors, many of which may be unrelated to a leak in the splice being tested. For example, as also indicated above, testing of the splice is performed at the well site given the fact that this is where the splice is formed. As a result, the environment of the oilfield may play a role in pressure detection and fluctuations. That is, rain, outside temperature and other climate or oilfield factors, may affect the pressure readings that are being obtained during a given test. As a result, failure may often be improperly detected on a non-leaking splice, or worse, a truly defective splice may be improperly determined to be effective to a pressure rating that it is unable to withstand.

### SUMMARY

A method of pressure testing an oilfield cable or other line. The method includes applying a predetermined pressure to the line and applying the same pressure to a representative comparison line. These separate applications of pressure may then be recorded over time. Thus, a differential of the recorded pressures may be analyzed for divergence from a predetermined acceptance boundary.

### BRIEF DESCRIPTION OF THE DRAWINGS

FIG. 1 is an overview depiction of an oilfield accommodating a well to receive a line that is subject to a pressure testing technique of differential analysis.

FIG. 2A is a front view of a test splice of the line supported and interfaced by surface equipment of FIG. 1 for the pressure testing technique thereof

FIG. 2B is a schematic representation of the pressure testing technique and equipment applied to the test splice of FIG. 2A and a representative comparison thereof

FIG. 3A is a chart representing different “pass” and “fail” ratings for pressure differentials of splices plotted against a predetermined acceptance boundary.

FIG. 3B is a comparative chart representing pressure testing plots of different “pass” and “fail” ratings of splices in absence of differential analysis.

FIG. 4 is a chart representing a host of different “pass” ratings for pressure differentials of several splices used to generate a predetermined acceptance boundary.

FIG. 5 is a chart representing an embodiment of a multi-staged technique for determining a “pass” or “fail” pressure rating of a line utilizing a differential technique.

FIG. 6 is a flow-chart summarizing an embodiment of utilizing pressure testing technique of differential analysis for testing a line or splice thereof

### DETAILED DESCRIPTION

Embodiments are described with reference to certain oilfield operations and cable splices for testing. In particular, intelligent completion operations are referenced in which splices are added to a line or permanent downhole cable, for example to accommodate downhole tools after running through a packer or other hardware. However, in other embodiments, techniques as detailed herein may be utilized to evaluate any number of different cable or line types whether in the oilfield or otherwise.

As opposed to splices, other connections or terminations for interfacing a gauge, tool, or other dowhole implement may be good candidates for pressure testing according to techniques detailed herein. Similarly, testing of any line portion, whether or not including such discrete connection may also be applicable to techniques herein. Along these lines, the term “linking piece” as used herein may be utilized to refer to any such feature for sake of pressure testing according to the techniques described. For example, this term may refer to any segment or portion of a larger overall line which may or may not include connections, splices, terminations, etc. Alternatively, the term “linking piece” may refer to a discrete feature such as a connection alone that is not necessarily incorporated into a larger overall line. This may include circumstances where a connection alone is utilized for attachment to a gauge and/or mandrel downhole without further incorporation into a more elongated line. Nevertheless, as used herein, the term “linking piece” may be applicable to such a feature. So long as a technique of analyzing a differential of recorded pressures between a known pressure rated piece and one subject to test is run against a predetermined acceptance boundary, reliable testing of the test piece may be achieved.

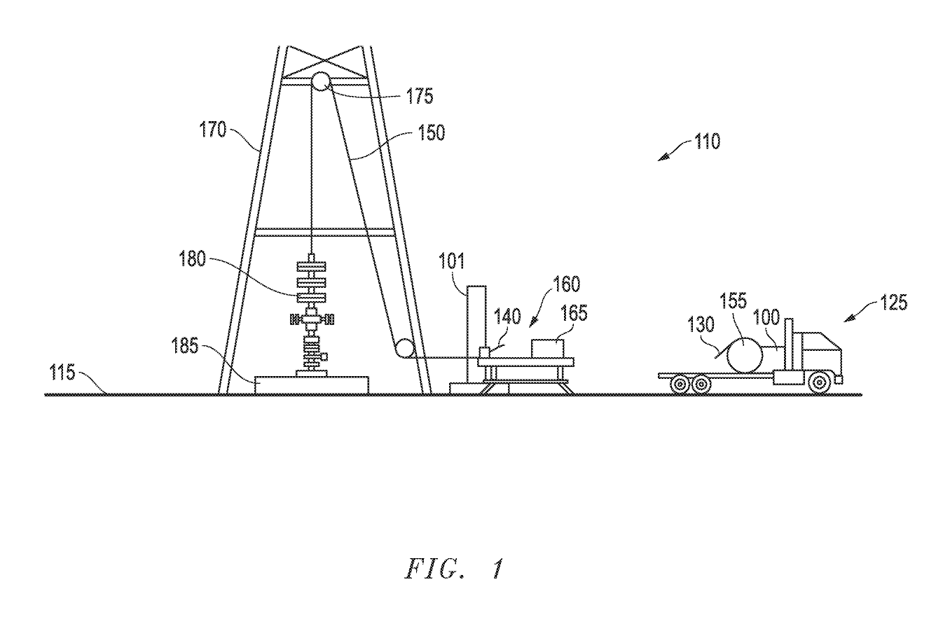

Referring now to FIG. 1, an overview depiction of an oilfield 115 is shown accommodating a well (see wellhead 185). Specifically, the well is to be outfitted with a line 150. The line 150 may be a wireline cable as shown. Alternatively, completions cables for lower, intermediate or upper completions hardware may be at issue. Regardless, the line 150 may be utilized for sake of delivering downhole power and/or telemetry as needed over the course of well operations.

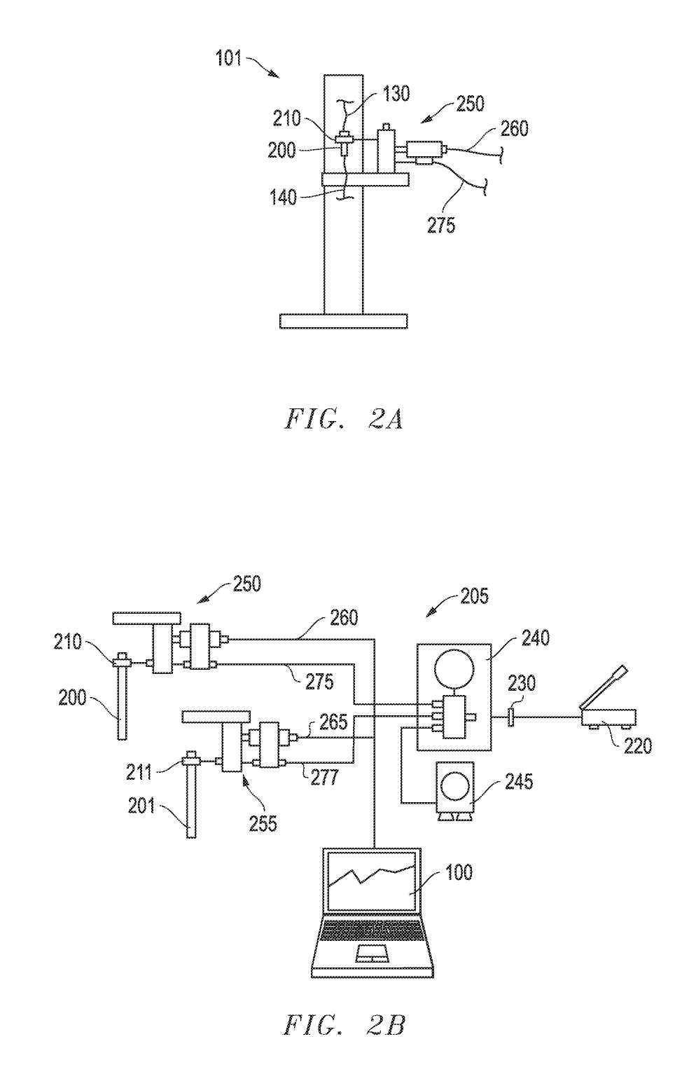

In the embodiment shown, the line 150 is subject to a pressure testing technique of differential analysis as carried out at a control unit 100 or other suitable computing device. For example, the line 150 may be delivered to the oilfield 115 with a pressure rating of 20,000 PSI and suitable for long-term deployment in a well environment, perhaps about 10 years. However, for sake of accommodating instrumentation, downhole tools, or coupling to another line 130, the line 150 may be cut. In the embodiment shown, the line 150 is cut at a splice table 160, leaving a terminal end 140 for coupling to another line 130 as noted. Thus, a splicing assembly 165 may be utilized to form a particular linking piece in the form of a splice 200 between the terminal end 140 of the initial line 150 and the new line 130 (see FIG. 2A).

With added reference to FIGS. 2A and 2B, the splice 200 may be tested according to a system and techniques detailed herein for suitability in a downhole environment. That is, just as the initial line 150 may be rated at 20,000 PSI in the example above, protocol will likely call for the splice 200 to be similarly rated. However, unlike the initial line 150 which may have been previously tested offsite, the splice 200 has just been formed at the oilfield 115. Thus, the need for on-site pressure testing of the splice 200 has emerged. In the embodiment shown, this testing may be performed by mounting of the splice 200 at a test platform 101 and hook-up to a test system 205 with ultimate analysis at the control unit 100 as detailed further below.

Continuing with reference to FIG. 1, the control unit 100 is provided as part of a mobile line delivery truck 125 with reel 155. Of course, additional line may be provided any number of ways and the computing device need not be an operations control unit 100 for applications at the oilfield 115. By the same token, the oilfield equipment 110 shown includes a conventional rig 170 with line supportive sheaves 175 over a blowout preventer 180. However again, any number of different oilfield equipment setups may take advantage of the line and/or splice pressure testing techniques detailed hereinbelow. In fact, more traditional completions may involve splicing right at the rig floor, on the tubing hardware to be deployed, as opposed to at a separate splice table 160.

Referring now to FIG. 2A, a front view of the test splice 200 is shown secured to a test platform 101. With reference to the example and FIG. 1 depiction referenced above, the splice 200 may constitute the structural coupling of the terminal end 140 of a downhole line 150 and another line 130, uphole thereof Regardless, in the embodiment of FIG. 2A, a C-ring 210 is fitted about the splice 200 for sealably pressurizable interface with the splice 200. Thus, a pressure valve assembly 250 may be utilized to direct pressure relative the interfaced splice 200. More specifically, an isolation line 275 may be used to direct a pressure held at the interface whereas a strand 260 of an electrical line or other detection instrument may be used to aid in monitoring of the held pressure.

With the above type of hook-up in mind, FIG. 2B depicts a schematic of an overall test system 205. The depicted system 205 employs the hook-up of the test splice 200 as indicated above. Further, the noted detection line includes the test strand 260 as indicated but also includes a comparison strand 265. That is, a representative comparison line or splice 201 may be hooked up to its own C-ring 211, pressure valve assembly 255, isolation line 277 and strand 265 of the detection line. In this manner, pressure testing on another splice 201 (i.e. “linking piece”) that is known to be non-leaking may take place in conjunction with the testing that takes place on the test splice 200. Thus, the detections for analysis at the control unit 100, depicted as a laptop in FIG. 2B, may be analyzed according to differential techniques described below. That is, the detection line is supplying data from both the test strand 260 and the comparison strand 265 simultaneously for analysis.

In the embodiment shown, the system 205 is employed by utilizing a pump such as the depicted hand pump 220 to supply pressure to the valve assemblies 250, 255 noted above. For example, a 20,000 PSI level may be routed through an isolation valve 230 and manifold 240 in reaching isolation lines 275, 277 that supply pressure through the noted C-rings 210, 211. Transducers of the valve assemblies 250, 255 may be coupled to the detections line strands 260, 265 as a primary check on pressure as described further below. Additionally, in the embodiment shown, a chart recorder 245 may be provided as a secondary check for the operator to monitor holding of such pressure by the overall system 205.

By having pressure readings available from both strands 260, 265 and splices 200, 201 at the same time, certain pressure affecting environmental conditions may be substantially eliminated from leak determination relative the test splice 200. For example, rain, heat or other atmospheric conditions might affect pressure readings from the strands 260, 265. However, both splices would be subject to these same conditions at the oilfield 115 (see FIG. 1). Therefore, rises or drops in pressure that are detected at the control unit 100 may be negated where such pressure changes are happening to both the test splice 200 and the splice 201 that is known not to leak. More specifically, analysis at the control unit 100 may relate to tracking a detected pressure differential between the two splices 200, 201. Thus, whenever both pressures rise or drop to substantially the same degree, the differential is largely unaffected. Alternatively, when there is a significant rise or drop, a leak in the test splice 200 may be determined to exist as detailed further below.

Of course, using a test splice 200 and a representative comparison splice 201 in this manner is most effective where the comparison splice 201 is truly a comparable. For example, as a matter of enhancing accuracy each splice 200, 201 may be of substantially the same volume, shape, dimensions, materials, architecture and other characteristics that are subject to playing a role in detected pressure, particularly in light of the surrounding environment. As a practical matter, this may mean that an assortment of different comparison splices 201 are available to an operator at the oilfield 115 based on the different types of test splices 200 that might actually be deployed downhole (see FIG. 1).

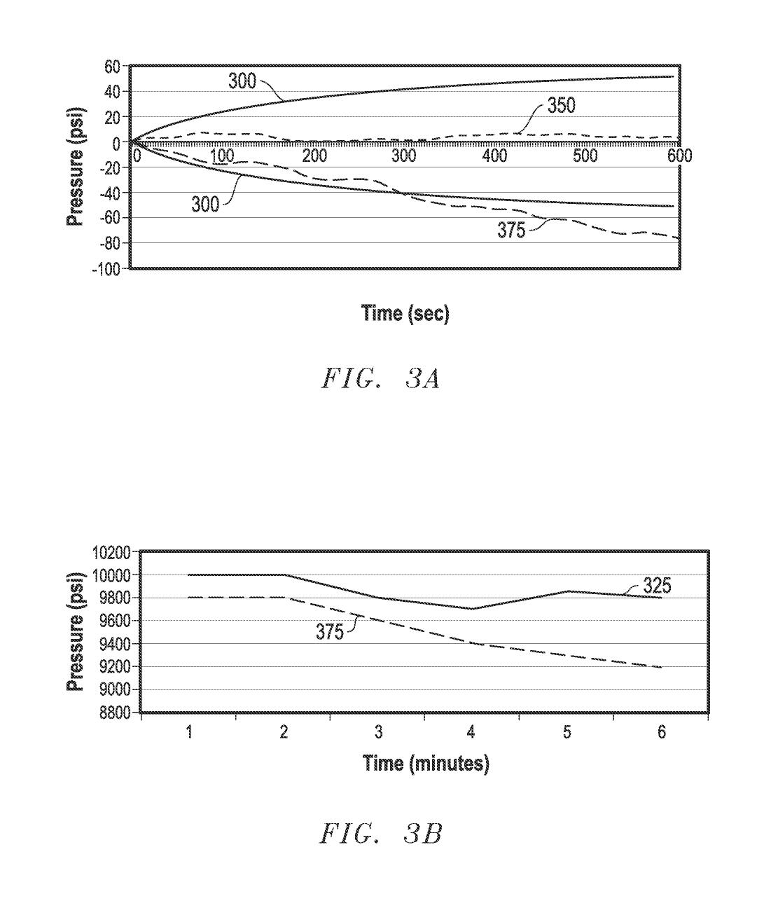

Referring now to FIGS. 3A and 3B, charts representing different plots of “pass” and “fail” ratings for different splice or line pressure measurements utilizing the system 205 of FIG. 2B are depicted. More specifically, FIG. 3A is a chart representing different “pass” 350 and “fail” 375 ratings for pressure differentials of two different test splices plotted against a predetermined acceptance boundary 300. FIG. 3B, on the other hand, is a chart representing more direct pressure testing of the same failed test splice 375 against a passing comparative splice 325 without reference to the boundary 300. In FIG. 3B, a natural bias error of about 200 PSI is present such that the held pressure of the different splices 325, 375 may be readily seen against one another. Indeed, the splices 325, 375 appear to maintain pressure at the same rate of consistency until about the four or five minute mark where pressure indicative of a leak emerges in the failed splice 375.

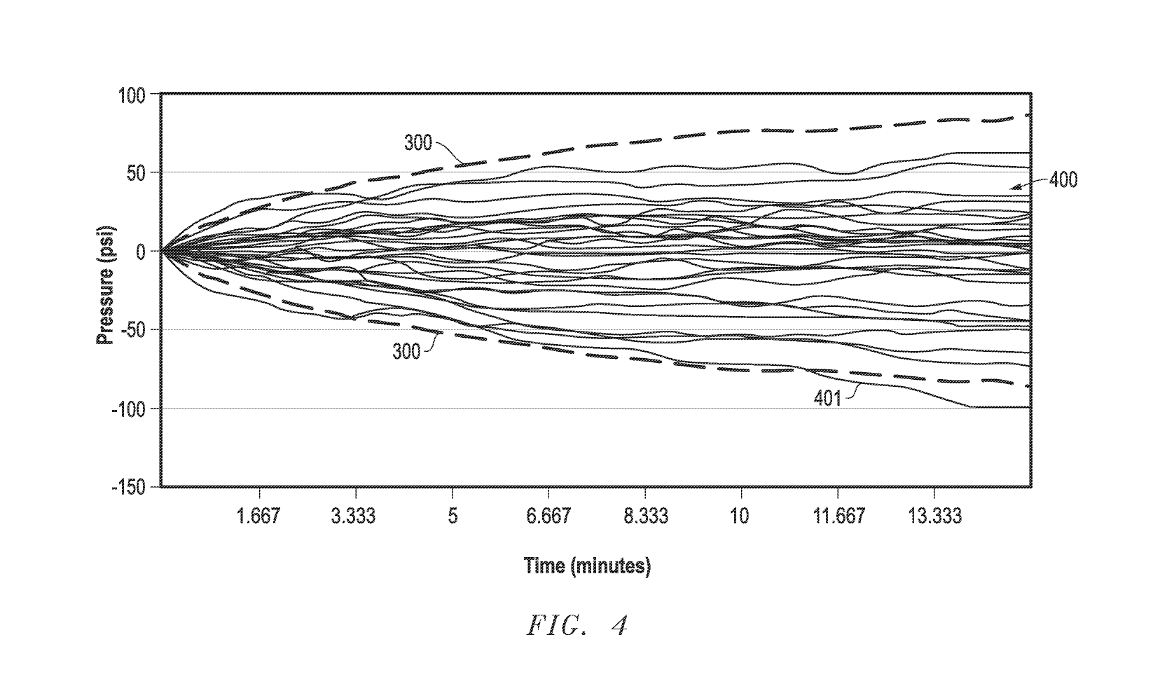

In the example of FIG. 3B above, the detection of the leak is visually apparent due to the divergence of the splice pressure plots 325, 375 (i.e. a growing differential). However, to enhance such detection, for example, where such a divergence may not be so visually apparent, a more quantified approach may be utilized as depicted in FIG. 3A. As indicated above, FIG. 3A depicts separate differential plot lines of passing 350 and failing 375 natures. That is, one tested splice, such as 200 of FIG. 2B, is rated as passing based on plotting of a pressure differential 350 relative the comparative splice 201 over a period of time. In fact, an acceptance boundary 300, established with a known confidence level based on prior testing of known passing splices and/or line testing is provided for reference. For example, in the embodiment shown, a confidence level of at least about 95% may be established for the acceptance boundary based on prior historical testing of non-leaking lines (e.g. see FIG. 4).

Continuing with reference to FIG. 3A, in contrast to the passing plot 350, a significant differential emerges for the failing plot 375. Indeed, at about 5 minutes, the plot 375 of the leaking line/splice crosses the predetermined acceptance boundary 300 and is officially failed based on the set criteria. This is consistent with FIG. 3B, which measures overall pressure drop as opposed to a differential. That is, in FIG. 3B the failure is visually apparent by the time the failing plot line 375 reaches the five minute mark. However, detection of this failure may be more quantifiably displayed and systematically dealt with where the differential is used in combination with a predetermined acceptance boundary 300 as depicted in FIG. 3A. While the chart of FIG. 3B is of value, the technique of FIG. 3A may provide the additional advantage of largely eliminating guesswork that might go into determinations without a set boundary 300.

Referring now to FIG. 4, a chart representing a host of different “pass” ratings for pressure differentials of several splices 400 is shown. That is, establishing the predetermined acceptance boundary 300 as detailed hereinabove may be a matter of historical and/or cumulative reference. For example, pressure differential plots of splices 400 depicted in FIG. 4 may be the result of testing a multitude (or plurality) of known non-leaking splices with the system 205 of FIG. 2B. More specifically, each differential plot line may be established by utilizing a comparative splice 201, such as the one of FIG. 2B, against another known non-leaking splice. This may be repeated over and over with the other known non-leaking splice being replaced with one of the same volume and other characteristics, generating a new differential plot line each time.

The predetermined acceptance boundary 300 may be set with different levels of confidence. For example, the boundary of FIG. 4 may be set at a 95% level of confidence. Indeed, as shown, even some differential readings for splices that are known to not be leaking 401 may fall outside of the boundary. However, in actual practice failing a splice associated with such a reading 401 would only mean unnecessarily discarding a splice. Alternatively, widening the boundary 300 would reduce the confidence level, for example to below 95%. Thus, in actual practice, the likelihood of passing a leaking splice such as 375 of FIG. 3A would be increased. While establishing a 100% confidence level may not be practical, a balance between the likelihood of undesirable false pass ratings versus the wasted expense of false fail ratings, due to a higher confidence level, may be a matter of operator preference.

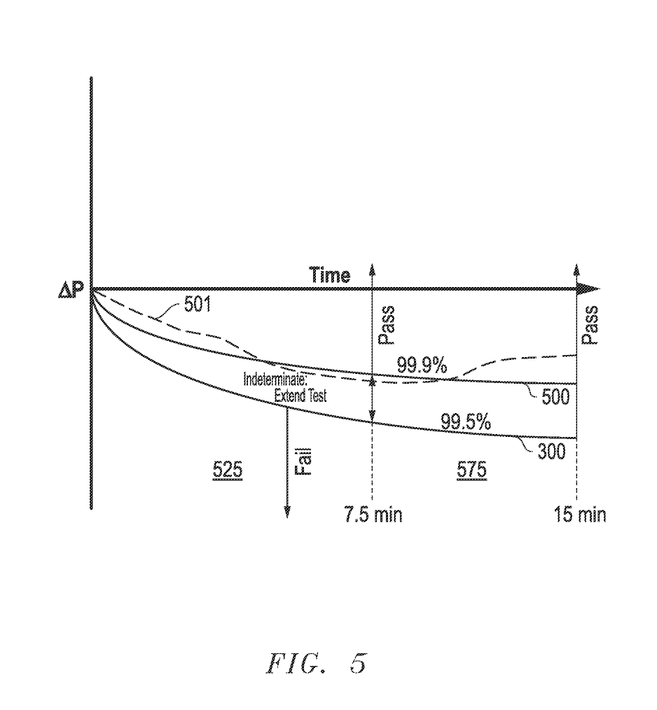

As shown in FIG. 4, the boundary 300 takes on a form that initially widens from a zero differential, but levels off over time as noise related readings from non-leaking splices or lines should begin to settle. Other characteristics of such a chart are also informative and may be utilized in various ways. For example, if the detections for the comparative splice 201 in the system 205 of FIG. 2B is always subtracted from the detection for the test splice 200, then a leak will be indicated only by the differential falling below the boundary 300. Alternatively, positive differentials, particularly those above the boundary 300 would be the result of noticeable noise. Additionally, another manner of utilizing this type of information may be with application of different boundaries 300, 500 examined over different intervals 525, 575 as described below (see FIG. 5).

Referring now to FIG. 5, a chart representing an embodiment of a multi-staged technique for determining a “pass” or “fail” pressure rating of a line utilizing a differential technique. The chart references pressure differentials (AP) and predetermined acceptance boundaries 300, 500 only in the negative for sake of leak focused detection as alluded to above. Further, as also indicated above, an analysis technique may be employed in which these different boundaries 300, 500 are examined over different time periods or intervals 525, 575.

Continuing with reference to FIG. 5, with added reference to FIG. 2B, testing intervals 525, 575 of about 7½ minutes are sequentially charted, though any practical time period may be selected. In the embodiment shown, a test may be run with the system 205 of FIG. 2B, wherein a differential 501 is monitored over the course of the initial interval 525. In a circumstance where the differential remains within the 99.9% confidence boundary 500 for the interval 525, testing may be stopped and the test splice 200 considered passing. Alternatively, where the differential falls below the 95% boundary 300 during the initial interval 525, the testing may be stopped and the test splice 200 considered as failed. Therefore, in likely the vast majority of cases, pressure testing of a splice 200 may take little more than the 7½ minutes of test time.

In the minority of cases, testing of the splice 200 may reveal a differential 501 that is between the noted boundaries 300, 500 during the initial interval 525. Indeed, this the circumstance depicted in FIG. 5. When this occurs, testing may be continued into the second interval 575, for another 7½ minutes in the example shown. Thus, if the differential 501 settles out and returns to within the 99.9% boundary 500 as in the example shown, it may be considered indicative of a passing grade for the splice 200. On the other hand, if the differential 501 fails to return to within the 99.9% boundary 500, a failing pressure grade may be assigned to the splice 200.

Of course, any number of additional intervals 525, 575, or levels of confidence for the boundaries 300, 500 may be utilized in this manner. That is, it may be a matter of operator preference as to how long testing may be potentially extended and what degree of confidences may be employed. Regardless, the automatic 30-90 minutes of testing pressure testing for each and every test splice, as conventionally required, may be avoided where embodiments of techniques such as these are employed.

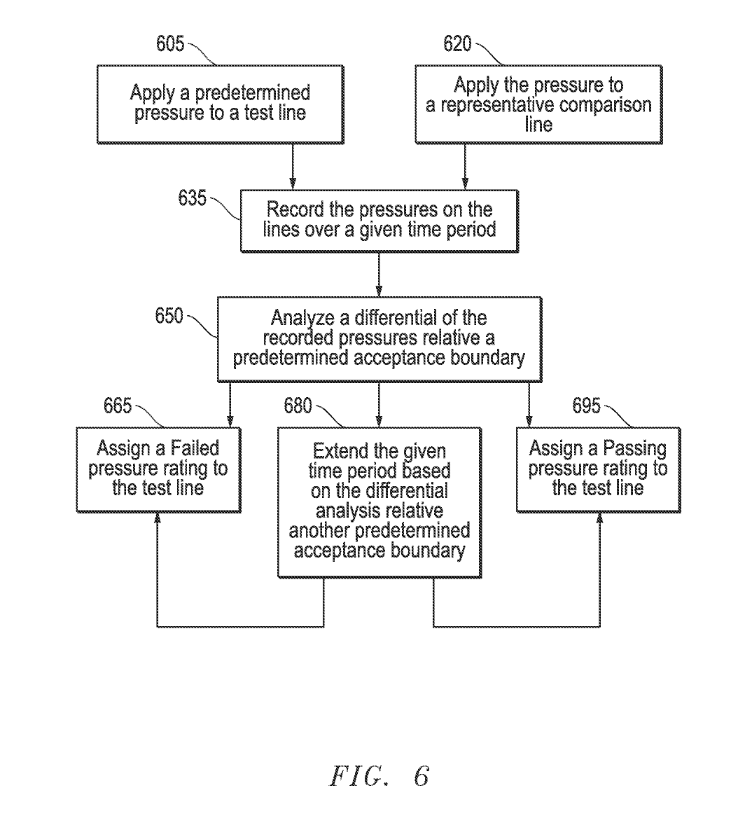

Referring now to FIG. 6, a flow-chart is depicted that summarizes embodiments of utilizing pressure testing techniques of differential analysis for testing a line or splice thereof As indicated at 605 and 620, a predetermined pressure may be applied to both a test line and a line that is a representative comparison of the test line that is known to not be leaking. The pressures may then be recorded over a given time period as indicated at 635 with a differential thereof analyzed relative a predetermined acceptance boundary (see 650).

With reference to the noted boundary, the line may either be assigned a failed (665) or passing (695) pressure rating. Additionally, in one embodiment, the differential analysis of 650 may be inconclusive. Therefore, the time period may be extended as indicated at 680 for further analysis with added reference to another predetermined acceptance boundary. Subsequently, the failed (665) or passing (695) pressure rating may be assigned.

Embodiments described hereinabove include techniques that allow for the dramatic reduction in overall pressure testing time for lines. This is particularly advantageous in the oilfield environment where many tests are required on many line splices, for example, due to the complexity of downhole hardware and tools. Further, the techniques detailed herein provide an added degree of reliability to testing at the oilfield or another environment where pressures are subject to variation due to surrounding weather or other factors.

The preceding description has been presented with reference to presently preferred embodiments. Persons skilled in the art and technology to which these embodiments pertain will appreciate that alterations and changes in the described structures and methods of operation may be practiced without meaningfully departing from the principle, and scope of these embodiments. For example, the analysis of pressure differentials may be further enhanced with reference to known parameters aside from a differential pressure predetermined acceptance boundary. This may include analysis with reference to a correlation coefficient such as a Pearson Product-Moment Correlation Coefficient. So, for example, a sharp change in differential may be caught as indicative of a leak even where the plot remains within a pressure differential-based predetermined acceptance boundary. Regardless, the foregoing description should not be read as pertaining only to the precise structures described and shown in the accompanying drawings, but rather should be read as consistent with and as support for the following claims, which are to have their fullest and fairest scope.

We claim:

1. A method of pressure testing a test linking piece of unknown leak characteristics, the method comprising:
applying a predetermined pressure to the test piece;
applying the predetermined pressure to a comparison linking piece of known non-leaking characteristics;
recording the pressures on the pieces over time; and
analyzing a differential of the recorded pressures relative a predetermined known parameter.

2. The method of claim 1 wherein the test piece is one of a splice, a connection and a line termination, the method further comprising assembling the one of the splice, the connection and the termination at an oilfield prior to said applying of the predetermined pressure thereto.

3. The method of claim 1 wherein the known parameter is a pressure differential based acceptance boundary.

4. The method of claim 3 further comprising establishing the known parameter of the acceptance boundary with a level of confidence based on prior testing of linking pieces of known non-leaking characteristics.

5. The method of claim 4 wherein the level of confidence is at least about 95%.

6. The method of claim 3 further comprising assigning one of a failed pressure rating to the test piece and a passing pressure rating to the test piece based on divergence of the differential from the acceptance boundary.

7. The method of claim 6 further comprising subtracting the recorded pressure of the comparison piece from the recorded pressure of the test piece to establish the differential.

8. The method of claim 7 wherein a negative value for the differential below the acceptance boundary directs said assigning of the failed pressure rating to the test piece.

9. The method of claim 1 wherein the predetermined known parameter is a correlation coefficient.

10. The method of claim 9 wherein the correlation coefficient is a Pearson Product-Moment Correlation Coefficient.

11. A method of pressure testing a linking piece of unknown leak characteristics, the method comprising:
establishing a predetermined acceptance boundary of differential pressure with a first confidence level;
establishing another predetermined acceptance boundary of differential pressure with a second confidence level below that of the first;
applying substantially the same predetermined pressure to the test piece and separately to a comparison linking piece of known non-leaking characteristics;
recording the pressures on the pieces for a predetermined interval of time; and
analyzing a differential of the recorded pressures for divergence from at least one of the predetermined acceptance boundaries.

12. The method of claim 11 wherein said analyzing further comprises assigning a failed rating to the test piece where the differential falls outside of the second confidence level acceptance boundary during the predetermined interval of time.

13. The method of claim 11 wherein said analyzing further comprises assigning a passing rating to the test piece where the differential falls within the first confidence level acceptance boundary during the predetermined interval of time.

14. The method of claim 11 wherein said analyzing further comprises extending said recording to beyond the predetermined interval of time where the differential falls between the first and second confidence level acceptance boundaries during the predetermined interval of time.

15. A system for pressure testing a test line portion of unknown leak characteristics, the system comprising:
a platform for supporting separate sealed pressurizable interfaces with each of the test line portion and a comparison line portion of known non-leaking characteristics;
at least one pump for applying substantially the same predetermined pressure to each line portion; and
a computing device with a pressure detection instrument for analyzing a differential of the pressures for divergence from a predetermined acceptance boundary.

16. The system of claim 15 wherein the sealed pressurizable interfaces comprise separate C-ring clamps at the line portions.

17. The system of claim 16 further comprising pressure valve assemblies to regulate pressure delivered and detected at the interfaces.

18. The system of claim 15 wherein each of the line portions are one of a splice, a connection and a line termination at an oilfield.

19. The system of claim 18 wherein the test line portion is one of a power and telemetry line to support downhole completions.

20. The system of claim 15 wherein the comparison line portion shares a characteristic that is substantially the same as that of the test line portion, the characteristic selected from a group consisting of volume, shape, dimension, material construction, and architecture.
